(19) United States
(12) Patent Application Publication
(10) Pub. No.: US 2026/0202127 A1
(43) Pub. Date: Jul. 16, 2026

(54) LASER DRYING DEVICE

(71) Applicant: TOYOTA JIDOSHA KABUSHIKI KAISHA, Aichi-ken (JP)

(72) Inventors: Masato ONO, Nagoya-shi (JP); Tadashi TERANISHI, Toyota-shi (JP); Yusuke OISHI, Toyota-shi (JP); Tomofumi HIRUKAWA, Miyoshi-shi (JP); Yosuke SHIMURA, Nagakute-shi (JP); Hiroshi KAWASAKI, Toyota-shi (JP); Katsuhisa TSUZUKI, Toyota-shi (JP); Takashi IZU, Kashiba-shi (JP)

(21) Appl. No.: 19/441,852

(22) Filed: Jan. 7, 2026

(30) Foreign Application Priority Data
Jan. 14, 2025 (JP) 2025-004981

(51) Int. Cl. F26B 3/28; H01M 4/04

(52) U.S. Cl. CPC F26B 3/283; H01M 4/0471

(57) ABSTRACT

A laser drying device for drying an electrode mixture layer, wherein the laser drying device includes a furnace body and a laser light source, the furnace body includes a laser-transmitting protective plate comprising a plurality of laser-transmitting protective plate pieces which transmit laser light, the laser light source irradiates the electrode mixture layer in the furnace body with laser light via the laser-transmitting protective plate, the plurality of laser-transmitting protective plate pieces are aligned in a plane direction, and adjacent laser-transmitting protective plate pieces are joined to each other via a gel substance or arranged with a gap.

### FIELD

The present disclosure relates to a laser drying device.

### BACKGROUND

As a method for drying an electrode mixture layer applied upon a current collector layer, laser drying is known. Laser drying consumes less energy than hot air drying and has a lower environmental impact. Various proposals for improving the drying efficiency and quality of laser drying have been made.

Patent Literature 1 discloses a method for the production of an electrode sheet, comprising a coating step of coating a surface of a long metal sheet with an active material paste while transporting the metal sheet, and a drying step, which is carried out in parallel with the coating step, of drying the active material paste on the metal sheet while transporting the metal sheet coated with the active material paste through a drying oven, in which hot air is blown in the transport direction of the metal sheet and light is emitted from at least one light source onto the active material paste on the metal sheet, wherein the temperature of the active material paste becomes higher than the temperature inside the drying oven due to the light irradiation. Patent Literature 1 describes that, according to the disclosure of Patent Literature 1, the temperature of the active material paste can easily be controlled and the active material paste can be uniformly dried in a short time.

Patent Literature 2 discloses a method for the production of an electrode, comprising an application step of applying an active material mixture containing an active material, a solvent, a conductive material, and a binder to a preset mixture application location of a conveyed elongated metal foil to form a coated portion of the active material mixture, a first irradiation step, which is performed before the application step, of irradiating, with a laser beam, an irradiation location of the elongated metal foil located upstream of both ends of the mixture application location along the short side of the elongated metal foil in the conveyance direction of the elongated metal foil, a second irradiation step, which is performed after the first irradiation step, of irradiating, with a laser beam, both short side edges of the coated portion formed by the application step, and a drying step, which is performed after the second irradiation step, of drying the coated portion. Patent Literature 2 describes, according to the disclosure of Patent Literature 2, providing a method for the production of an electrode with which sagging of the edges of the coated portion and shedding of the conductive material from the edges can be suppressed.

Patent Literature 3 discloses an electrode drying method, comprising a constant-rate drying step of drying an electrode substrate coated with an electrode slurry while it is conveyed at an inclined angle relative to the horizontal plane, and a decreasing-rate drying step of drying the electrode substrate while it is conveyed horizontally. Patent Literature 3 describes that, according to the disclosure of Patent Literature 3, the rising of binder components during the electrode drying process can be suppressed, whereby the adhesive strength between the electrode mixture layer and the electrode current collector can be improved.

### CITATION LIST

### Patent Literature

[PTL 1] Japanese Unexamined Patent Publication (Kokai) No. 2024-39889
[PTL 2] Japanese Unexamined Patent Publication (Kokai) No. 2019-29256
[PTL 3] Japanese Unexamined Patent Publication (Kokai) No. 2023-504346

### SUMMARY

### Technical Problem

The furnace body comprises a laser-transmitting protective plate having laser-transmission properties, and the electrode mixture layer inside the furnace body is irradiated with laser light from the laser light source through the protective plate, whereby the laser light source can be insulated from the furnace body. As a result, the need to arrange the laser light source inside the high-temperature furnace body is eliminated.

Furthermore, by shortening the distance between the laser-transmitting protective plate and the electrode mixture layer, the size of the furnace body can be reduced, and drying efficiency can be increased. In this case, since the distance between the laser-transmitting protective plate and the laser light source increases, and the area irradiated by the laser light on the laser-transmitting protective plate becomes larger, a large-area laser-transmitting protective plate is necessary.

However, it is difficult to prepare a single large-area laser-transmitting protective plate constituted by quartz glass or the like. Though joining of a plurality of laser-transmitting protective plate pieces to construct a laser-transmitting protective plate has been considered in response thereto, when the temperature inside the furnace body becomes high, the pieces thermally expand and become prone to thermal cracking.

Thus, an object of the present disclosure is to provide a highly efficient laser drying device.

### Solution to Problem

The present disclosure achieves the object described above by the following means.

### Aspect 1

A laser drying device for drying an electrode mixture layer, wherein
the laser drying device comprises a furnace body and a laser light source,
the furnace body comprises a laser-transmitting protective plate comprising a plurality of laser-transmitting protective plate pieces which transmit laser light,
the laser light source irradiates the electrode mixture layer in the furnace body with laser light via the laser-transmitting protective plate,
the plurality of laser-transmitting protective plate pieces are aligned in a plane direction, and
adjacent laser-transmitting protective plate pieces are joined to each other via a gel substance or arranged with a gap.

### Aspect 2

The laser drying device according to Aspect 1, wherein the gel substance is selected from a fluorine-based gel, a silicone-based gel, an acrylic gel, and combinations of these.

### Aspect 3

The device according to Aspect 1 or 2, wherein adjacent laser-transmitting protective plate pieces are arranged with a gap, and a negative pressure is generated in the furnace body.

### Aspect 4

The device according to any one of Aspects 1 to 3, wherein the furnace body further comprises hot air supply equipment.

### Aspect 5

A method for the production of an electrode laminate using the device according to any one of Aspects 1 to 4, the method comprising the step of:
irradiating an electrode mixture layer applied to a current collector layer with laser light.

### Advantageous Effects of Invention

According to the present disclosure, there can be provided a highly efficient laser drying device.

### BRIEF DESCRIPTION OF DRAWINGS

FIG. 1 is a schematic view detailing a laser drying device of the present disclosure.

FIG. 2 is a schematic view detailing the laser drying device of the present disclosure.

FIG. 3 is a schematic view detailing the laser drying device of the present disclosure.

FIG. 4A is a schematic view detailing the laser drying device of the present disclosure.

FIG. 4B is a schematic view detailing the laser drying device of the present disclosure.

FIG. 4C is a schematic view detailing the laser drying device of the present disclosure.

### DESCRIPTION OF EMBODIMENTS

The embodiments of the present disclosure will be described in detail below. Note that the present disclosure is not limited to the following embodiments, and various modifications can be made within the scope of the spirit of the present disclosure.

### <<Laser Drying Device>>

A laser drying device for drying an electrode mixture layer, wherein
the laser drying device comprises a furnace body and a laser light source,
the furnace body comprises a laser-transmitting protective plate comprising a plurality of laser-transmitting protective plate pieces which transmit laser light,
the laser light source irradiates the electrode mixture layer in the furnace body with laser light via the laser-transmitting protective plate,
the plurality of laser-transmitting protective plate pieces are aligned in a plane direction, and
adjacent laser-transmitting protective plate pieces are joined to each other via a gel substance or arranged with a gap.

According to the present disclosure, there can be provided a highly efficient laser drying device.

The present inventors have investigated arranging a laser-transmitting protective plate on the furnace body in order to insulate the laser light source from the interior of the furnace body when laser drying the electrode mixture layer. Further, to improve drying efficiency, it is necessary to secure a large distance between the laser light source and the electrode mixture layer, necessitating a large-area laser-transmitting protective plate.

The present inventors have found that the above problem can be solved by constructing the laser-transmitting protective plate from a plurality of laser-transmitting protective plate pieces. Adjacent laser-transmitting protective plate pieces are joined to each other via a gel substance or arranged with gaps therebetween, whereby thermal expansion of the laser-transmitting protective plate is absorbed by the gel substance or the gaps, suppressing thermal cracking of the laser-transmitting protective plate.

Thus, since the distance between the laser-transmitting protective plate and the electrode mixture layer inside the furnace body can be reduced, drying efficiency can be improved.

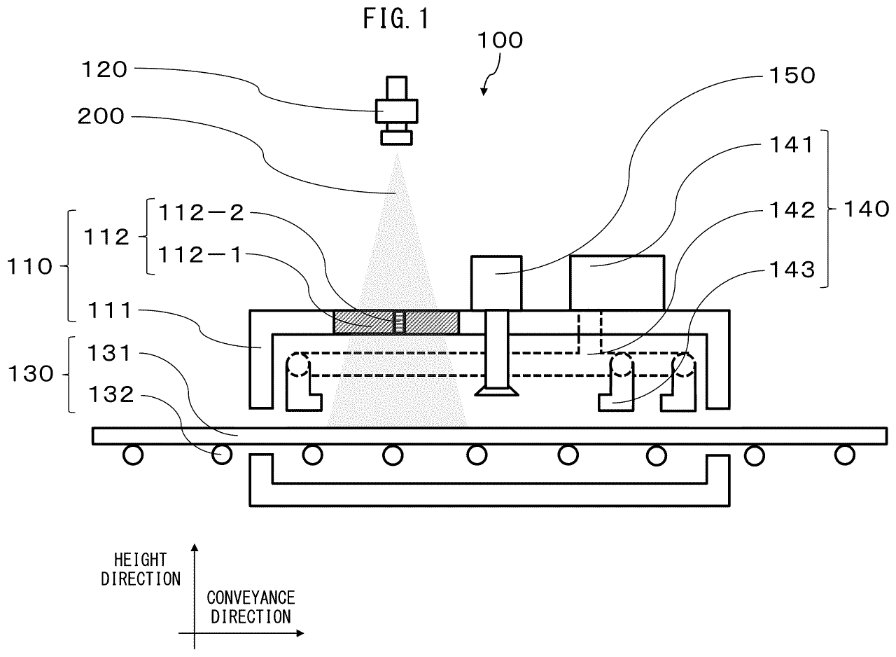

Specifically, as shown in, for example, FIG. 1, the laser drying device 100 comprises a furnace body 110 and a laser light source 120. The laser drying device 100 further comprises conveying equipment 130, and by rotating conveyor rollers 132, the electrode mixture layer arranged on a conveyor belt 131 is moved at a constant speed in the conveyance direction. Thus, the electrode mixture layer can be introduced from outside of the furnace body 110 to the interior of the furnace body 110, and the electrode mixture layer can be conveyed from the interior of the furnace body 110 to the outside of the furnace body 110.

The furnace body 110 is constituted by an exterior base material 111 and a laser-transmitting protective plate 112. The electrode mixture layer introduced into the interior of the furnace body 110 by the conveying equipment 130 is irradiated with laser light 200 from the laser light source 120 arranged outside the furnace body 110 via the laser-transmitting protective plate 112.

The laser-transmitting protective plate 112 is constituted by a plurality of laser-transmitting protective plate pieces 112-1, which are arranged in a plane direction, and adjacent laser-transmitting protective plate pieces 112-1 are joined to each other via a gel substance 112-2.

Furthermore, the laser drying device 100 comprises hot air supply equipment 140, and the hot air supply equipment 140 is constituted by a hot air generator 141, an air supply duct 142, and an air supply nozzle 143. The hot air supply equipment 140 supplies hot air generated by the hot air generator 141 to the interior of the furnace body 110 via the air supply duct 142 and the air supply nozzle 143. The hot air is supplied in the conveyance direction and in the direction facing the conveyance direction. Steam generated near the surface of the electrode mixture layer due to the laser irradiation is removed by the hot air and is then exhausted outside the furnace body 110 by exhaust equipment 150. As a result, drying efficiency of the electrode mixture layer can be increased.

Note that though the interior of the furnace body 110 is heated to a high temperature by the hot air, since the laser-transmitting protective plate 112 is present between the laser light source 120 and the interior of the furnace body 110, the laser light source 120 is protected from the heat in the interior of the furnace body 110, which is not transferred thereto.

The laser drying device of the present disclosure is a laser drying device for drying an electrode mixture layer.

The phrase “electrode mixture” as used herein refers to a composition that can constitute an electrode active material layer either as-is or by further containing other components. Further, the phrase “electrode mixture layer” refers to a layer which contains a dispersion medium in addition to the “electrode mixture” and which can be applied and dried to form an electrode active material layer.

The laser drying device of the present disclosure comprises a furnace body and a laser light source. The laser drying device may further comprise conveying equipment, hot air supply equipment, and exhaust equipment.

The energy density of the laser light emitted from the laser light source onto the electrode mixture layer in the drying furnace is not particularly limited, and may be, for example, 0.1 W/cm² or more, 0.5 W/cm² or more, 1.0 W/cm² or more, 2.0 W/cm² or more, or 3.0 W/cm² or more, and may be 20.0 W/cm² or less, 10.0 W/cm² or less, 7.0 W/cm² or less, or 4.0 W/cm² or less.

When the distance between the laser light source and the electrode mixture layer is defined as x, and the distance between the laser-transmitting protective plate and the electrode mixture layer is defined as y, y/x≤0.15, 0.14, 0.13, 0.12, 0.10, 0.08, or 0.05 may be satisfied. By satisfying the above relationship, drying efficiency of the electrode mixture layer is increased. Furthermore, y/x≥0.01, 0.02, 0.03, or 0.04 may be satisfied.

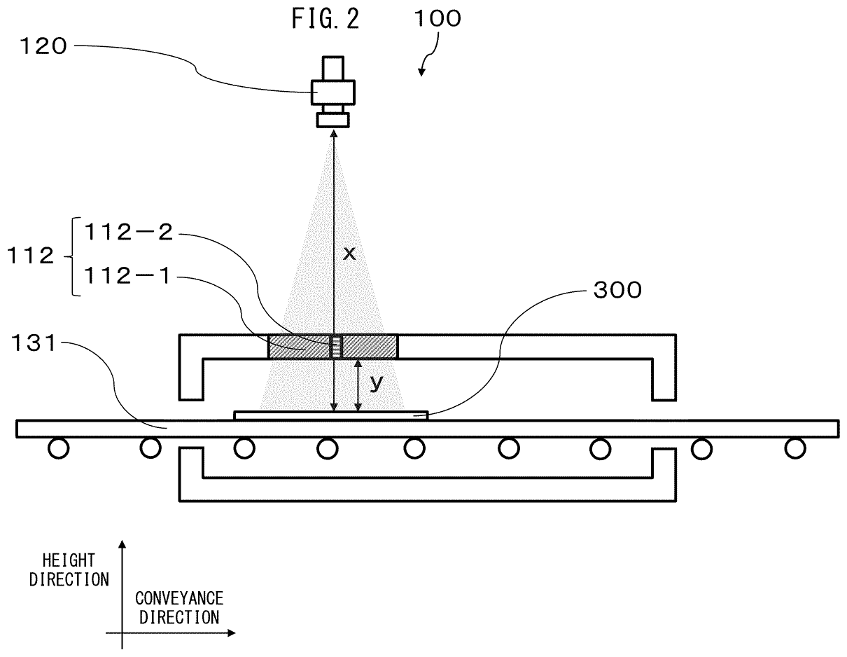

Specifically, as shown in, for example, FIG. 2, an electrode mixture layer 300 is arranged on the conveyor belt 131 and is irradiated with laser light. The distance x described above is the shortest distance from the laser light irradiation portion of the laser light source 120 to the electrode mixture layer 300 in the height direction. Furthermore, the distance y described above is the shortest distance from the laser-transmitting protective plate 112 to the electrode mixture layer 300 in the height direction.

The distance x between the laser light source and the electrode mixture layer is not particularly limited, and may be determined appropriately taking into consideration the irradiation area of the laser light, etc. The distance x may be, for example, 300 mm or more, 500 mm or more, 1000 mm or more, 1500 mm or more, or 2000 mm or more, and may be 5000 mm or less, 4000 mm or less, or 3000 mm or less. The laser light source may be arranged in the interior of the furnace body, or may be arranged outside the furnace body.

The distance y between the laser-transmitting protective plate and the electrode mixture layer is not particularly limited, and may be determined appropriately taking into consideration y/x, the thickness of the electrode mixture layer, etc. The distance y may be, for example, 5 mm or more, 10 mm or more, 30 mm or more, 50 mm or more, or 100 mm or more, and may be 750 mm or less, 500 mm or less, 400 mm or less, or 300 mm or less.

### <Furnace Body>

The furnace body comprises a laser-transmitting protective plate. As shown in FIG. 1, the furnace body includes an exterior base material and a laser-transmitting protective plate, and at least a part of the exterior of the furnace body may be the laser-transmitting protective plate. The laser-transmitting protective plate may be arranged at a position where the electrode mixture layer can be thoroughly irradiated with the laser light generated from the laser light source via the laser-transmitting protective plate.

The material of the exterior base material is not particularly limited, and may be, for example, steel, stainless steel, aluminum, etc. The exterior base material may be surface-treated by galvanization, powder coating, etc. The size of the furnace body is not particularly limited, and may be determined appropriately in consideration of the dimensions of the electrode mixture layer, etc.

The dimensions of the furnace body are not particularly limited and may be determined appropriately taking into consideration the dimensions of the electrode mixture layer, etc. The furnace body may also have an opening for carrying in and out the electrode mixture layer using conveying equipment.

The furnace body preferably has high thermal insulation properties from the viewpoint of increasing drying efficiency of the electrode mixture layer, and may have a thermal insulation material on the outside of the exterior base material. Examples of the thermal insulation material include fire brick, ceramic fiber, and glass wool.

### (Laser-Transmitting Protective Plate)

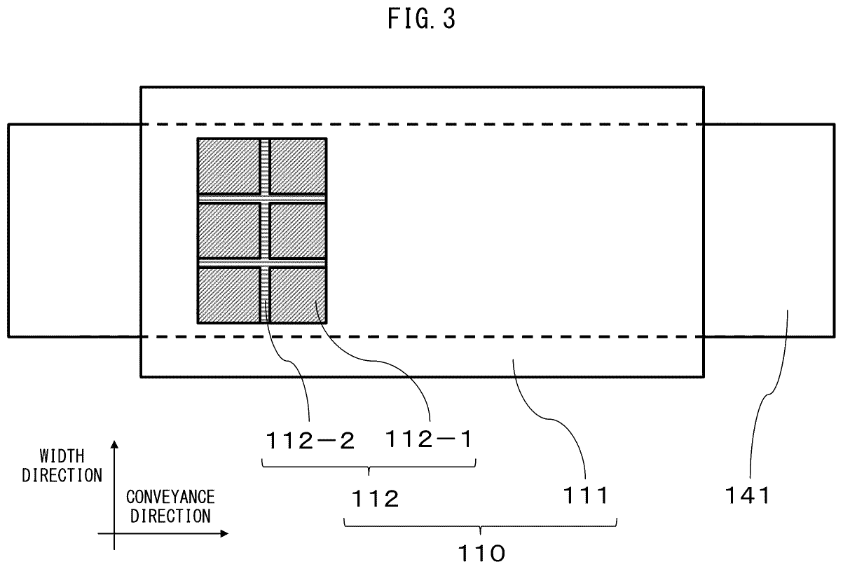

The laser-transmitting protective plate comprises a plurality of laser-transmitting protective plate pieces which transmit laser light. The plurality of laser-transmitting protective plate pieces are arranged in a plane direction. In the present disclosure, the “plane direction” of the protective plate pieces refers to the direction parallel to the primary surface (largest surface) of the protective plate pieces. Specifically, for example, this refers to any direction perpendicular to the height direction of the furnace body in FIG. 1. As shown in FIG. 3, the laser-transmitting protective plate pieces 112-1 may be arranged in either the width direction or the conveyance direction. The number of laser-transmitting protective plate pieces is not particularly limited, and may be appropriately determined in consideration of the dimensions of the laser-transmitting protective plate pieces and the area of the laser-transmitting protective plate irradiated by the laser light.

The laser light transmittance of the laser-transmitting protective plate pieces, with respect to the laser light emitted from the laser light source, may be 95.0% or more, 96.0% or more, 97.0% or more, 98.0% or more, 99.0% or more, 99.5% or more, or 99.8% or more, and may be 100.0% or less or 99.9% or less. By adopting high laser light transmittance, the light energy generated from the laser light source can efficiently be supplied to the electrode mixture layer.

The transmittance of laser light is the transmittance at a single wavelength when the laser light is of a single wavelength, and is the transmittance at the wavelength having the highest intensity when the laser light is of multiple wavelengths. The transmittance of laser light can be measured by spectrophotometry using a UV-Vis-NIR spectrophotometer (SolidSpec-3700 DUV, manufactured by Shimadzu Corporation).

The material of the laser-transmitting protective plate pieces may be a glass. The glass may be, for example, quartz glass, soda-lime glass, lead glass, borosilicate glass, or alkali glass.

The laser-transmitting protective plate pieces may be double-glazed glass, which improves heat insulation performance. The double-glazed glass may be formed by sealing air, argon gas, krypton gas, etc., between a plurality of panes of glass.

The thickness of the laser-transmitting protective plate pieces is not particularly limited, and may be appropriately determined in accordance with the material of the laser-transmitting protective plate pieces, etc. The thickness of the laser-transmitting protective plate pieces may be, for example, 1 mm or more, 3 mm or more, 5 mm or more, 7 mm or more, or 10 mm or more, and may be 30 mm or less, 25 mm or less, 20 mm or less, or 15 mm or less.

The dimensions of the laser-transmitting protective plate pieces are not particularly limited, and may be selected such that the laser light generated from the laser light source can thoroughly pass therethrough to the furnace body interior when the plurality of transmitting plate pieces are combined.

The thermal conductivity of the laser-transmitting protective plate pieces is not particularly limited, and may be 1.50 W/(m·K) or less, 1.40 W/(m·K) or less, 1.38 W/(m·K) or less, 1.35 W/(m·K) or less, 1.30 W/(m·K) or less, 1.20 W/(m·K) or less, 1.10 W/(m·K) or less, or 1.00 W/(m·K) or less, and may be 0.10 W/(m·K) or more, 0.30 W/(m·K) or more, or 0.50 W/(m·K) or more. By adopting a low thermal conductivity, the laser light source is less likely to be impacted by the temperature of the furnace body interior.

The thermal conductivity can be measured by the heat flow meter method in accordance with ASTEM-E-1530.

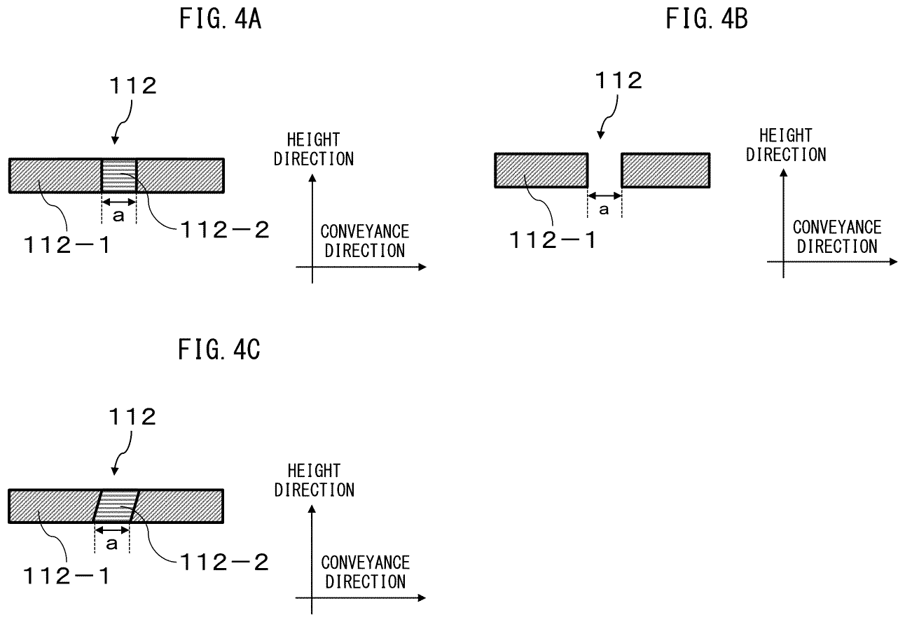

Adjacent laser-transmitting protective plate pieces are joined to each other via the gel substance or arranged with a gap. Specifically, for example, as shown in FIG. 4A, adjacent laser-transmitting protective plate pieces 112-1 may be joined to each other via the gel substance 112-2, or as shown in FIG. 4B, the laser-transmitting protective plate 112 may not comprise the gel substance, and adjacent laser-transmitting protective plate pieces 112-1 may be arranged with a gap. The shape of the gel substance or the gap is not particularly limited, and an inclined shape as shown in FIG. 3(c) may be adopted.

When adjacent laser-transmitting protective plate pieces are joined to each other via the gel substance, a positive pressure may be applied to the furnace body, which prevents the gel substance from leaking between adjacent laser-transmitting protective plate pieces and into the furnace body.

When adjacent laser-transmitting protective plate pieces are arranged with a gap therebetween, the furnace body may be under negative pressure, which can prevent heat from leaking from the furnace body through the gap between the laser-transmitting protective plate pieces.

The spacing between adjacent laser-transmitting protective plate pieces is not particularly limited, and may be appropriately determined in consideration of the thermal expansion coefficient of the laser-transmitting protective plate pieces, the flexibility of the gel substance, etc. The spacing between adjacent laser-transmitting protective plate pieces may be, for example, 50 μm or more, 100 μm or more, 500 μm or more, 1 mm or more, 2 mm or more, or 3 mm or more, and may be 10 mm or less, 7 mm or less, or 5 mm or less. This spacing corresponds to the distance a, i.e., the length of the gel substance in the conveyance direction in FIG. 4A or the distance a in the conveyance direction of the gap in FIG. 4B. Furthermore, the spacing between adjacent laser-transmitting protective plate pieces in the conveyance direction may be approximately constant in the width direction, and the spacing between adjacent laser-transmitting protective plate pieces in the width direction may be approximately constant in the conveyance direction. Furthermore, the spacing between adjacent laser-transmitting protective plate pieces in the conveyance direction may be approximately the same as the spacing between adjacent laser-transmitting protective plate pieces in the width direction.

The gel substance may be selected from fluorine-based gels, silicone-based gels, acrylic-based gels, and combinations thereof. The gel substance is preferably a material which facilitates the transmission of laser light, has low thermal conductivity, and is soft.

The laser light transmittance of the gel substance may be 80.0% or more, 85.0% or more, 90.0% or more, 95.0% or more, 99.0% or more, 99.5% or more, or 99.8% or more with respect to the laser light irradiated from the laser light source, and may be 100.0% or less or 99.9% or less. High laser light transmittance allows the light energy generated from the laser light source to be efficiently supplied to the electrode mixture layer. The laser light transmittance of the gel substance may be 80.0% or more, 85.0% or more, 90.0% or more, or 95.0% or more with respect to the laser light transmittance of the laser-transmitting protective plate pieces, or may be 100.0% or less with respect to the laser light transmittance of the laser-transmitting protective plate pieces. The small difference between the laser light transmittance of the gel substance and that of the laser-transmitting protective plate pieces enables suppression of uneven irradiation of the electrode mixture layer with the laser light.

The transmittance of laser light is the transmittance at a single wavelength when the laser light is of a single wavelength, and is the transmittance at the wavelength having the highest intensity when the laser light is of multiple wavelengths. The transmittance of laser light can be measured by spectrophotometry using a UV-Vis-NIR spectrophotometer (SolidSpec-3700 DUV, manufactured by Shimadzu Corporation).

The refractive index of the gel substance is not particularly limited, and may be, for example, 1.60 or less, 1.55 or less, 1.50 or less, or 1.45 or less, and may be 1.00 or more, 1.10 or more, 1.20 or more, or 1.30 or more. The refractive index can be calculated by measuring the angle of incidence and the angle of refraction using a reflection method.

The thermal conductivity of the gel substance is not particularly limited, and may be 1.40 W/(m·K) or less, 1.20 W/(m·K) or less, 1.00 W/(m·K) or less, 0.80 W/(m·K) or less, 0.70 W/(m·K) or less, 0.60 W/(m·K) or less, or 0.50 W/(m·K) or less, and may be 0.10 W/(m·K) or more, 0.30 W/(m·K) or more, or 0.50 W/(m·K) or more. By adopting a low thermal conductivity, the laser light source is protected from impact due to the temperature of the furnace body interior. Thermal conductivity can be measured by the heat flow meter method in accordance with ASTEM-E-1530.

The heat resistance temperature of the gel substance is not particularly limited, and may be appropriately determined in consideration of the temperature of the interior of the furnace body, and may be, for example, 50° C. or higher, 100° C. or higher, 130° C. or higher, 150° C. or higher, 160° C. or higher, 180° C. or higher, 200° C. or higher, 220° C. or higher, 240° C. or higher, 260° C. or higher, 280° C. or higher, or 300° C. or higher, and may be 500° C. or lower, 450° C. or lower, 400° C. or lower, or 350° C. or lower.

The hardness of the gel substance is not particularly limited, and may be, for example, a Shore A hardness of 0 or more, 1 or more, 3 or more, 5 or more, 7 or more, or 10 or more, and may be 30 or less, 25 or less, or 20 or less. By adopting a soft gel substance, damage to the laser-transmitting protective plate due to thermal expansion of the laser-transmitting protective plate pieces can be prevented. The hardness (Shore A) of the gel substance can be measured in accordance with JIS-K-6253.

Fluorine-based gels are gels containing a fluorine compound, and a commercially available coating agent for optical applications, such as Novec Fluorochemical Gel (manufactured by 3M), can be used.

Silicone-based gels are gels containing a silicone compound, and a commercially available coating agent for optical applications can be used. The silicone-based gel may be, for example, a silicone gel such as Sylgard 527 (manufactured by Dow Chemical).

Acrylic gels are gels containing an acrylic resin, and a commercially available coating agent for optical applications can be used. The acrylic gel may be, for example, Cyrilite (manufactured by Rohm).

### <Laser Light Source>

The laser light source irradiates the electrode mixture layer in the furnace body with laser light via the laser-transmitting protective plate. Since the laser transmittance of the laser-transmitting protective plate is high, the light energy generated from the laser light source can be efficiently supplied to the electrode mixture layer.

The laser light source may be arranged outside the furnace body. By arranging the insulated laser light source outside the furnace body, the laser light source can be protected from high heat when the interior of the furnace body is at high temperature.

The type of the laser light source is not particularly limited, and may be, for example, a Yb fiber laser, a YAG laser, or a carbon dioxide laser. The wavelength of the laser light may be 0.5 μm or more, 0.6 μm or more, 0.7 μm or more, 0.8 μm or more, or 0.9 μm or more, and may be 1.5 μm or less, 1.4 μm or less, 1.3 μm or less, 1.2 μm or less, or 1.1 μm or less. The laser light may be of a single wavelength or of multiple wavelengths.

The output of the laser light source is not particularly limited, and may be appropriately determined in accordance with the irradiation area of the laser light, the possible irradiation time of the laser light, etc. The output of the laser light source may be, for example, 0.1 kW or more, 1 kW or more, 5 KW or more, 10 kW or more, 15 kW or more, 20 kW or more, or 30 kW or more, and may be 100 KW or less, 70 kW or less, or 50 kW or less.

The number of laser light sources is not particularly limited, and may be appropriately determined in accordance with the irradiation area of the laser light, the possible irradiation time of the laser light, etc. The number of laser light sources may be, for example, 1 or more, 2 or more, 3 or more, 5 or more, or 10 or more, and may be 30 or less, or 20 or less.

The shape of the area of the electrode mixture layer irradiated with the laser light may be, for example, rectangular. The size of the area of irradiation is not particularly limited, and may be appropriately determined in accordance with the dimensions of the electrode mixture layer.

### <Hot Air Supply Equipment>

The hot air supply equipment supplies hot air into the interior of the furnace body. By supplying hot air to the electrode mixture layer, steam can be removed from the surface of the electrode mixture layer, improving drying efficiency.

The temperature of the hot air supplied from the hot air supply equipment may be 50° C. or higher, 100° C. or higher, 130° C. or higher, 150° C. or higher, 160° C. or higher, 180° C. or higher, 200° C. or higher, 220° C. or higher, 240° C. or higher, 260° C. or higher, 280° C. or higher, or 300° C. or higher, and may be 500° C. or lower, 450° C. or lower, 400° C. or lower, or 350° C. or lower.

The hot air supply equipment is not particularly limited, and may be configured to supply air heated by, for example, gas combustion, oil combustion, electric heating, etc., to the electrode mixture layer by a blower fan through a blower duct and a blower nozzle. From the viewpoint of drying of the electrode mixture layer, it is preferable that the hot air have low humidity.

The supply direction of the hot air is not particularly limited, and may be the direction opposite to the conveyance direction when, for example, the electrode mixture layer is conveyed through the interior of the furnace body. Furthermore, a plurality of blowing nozzles may be arranged, and each nozzle may be arranged so as to have a different supply direction.

The air speed of the hot air is not particularly limited, and may be, for example, 5 m/s or more, 10 m/s or more, 15 m/s or more, or 20 m/s or more. A higher air speed increases drying efficiency of the electrode mixture layer. The air speed of the hot air may be 60 m/s or less, 50 m/s or less, 40 m/s or less, or 30 m/s or less.

### <Conveying Equipment>

The conveying equipment is not particularly limited, and may be, for example, a roller conveyor, a belt conveyor, etc. The electrode mixture layer may be arranged on, for example, a conveying path and introduced into the interior of the furnace body and conveyed to the outside of the furnace body.

The electrode mixture layer may be irradiated with laser light while being transported through the furnace body interior by the conveying equipment. In this case, the transport speed may be appropriately determined in consideration of the output of the laser light source, the amount of energy required to dry the electrode mixture layer, etc. The transport speed may be, for example, 0.1 m/s or more, 0.3 m/s or more, 0.5 m/s or more, or 1.0 m/s or more, or 3.0 m/s or less, 2.5 m/s or less, or 2.0 m/s or less.

The conveying equipment may be connected to other devices such as an electrode mixture layer application device and an electrode laminate winding device.

### <Exhaust Equipment>

The laser drying device may also comprise exhaust equipment. By providing exhaust equipment, steam generated from the electrode mixture layer can be recovered, thereby improving drying efficiency. The steam can be water vapor or other gases.

The exhaust equipment may be configured so as to, for example, suction in steam from an exhaust port by means of an exhaust fan and discharge the steam to the outside of the furnace body via an exhaust duct. The output of the exhaust fan and the dimensions of the exhaust port and exhaust duct may be appropriately determined in consideration of the amount of steam generated, the internal pressure of the furnace body, etc.

From the viewpoint of improving drying efficiency, it is preferable that the exhaust port be arranged above the electrode mixture layer and in a position which does not interfere with laser irradiation. The distance between the exhaust port and the electrode mixture layer may be such that vapor can be suctioned. The number of exhaust ports is not particularly limited.

### <<Electrode Laminate Production Method>>

A method for the production of an electrode laminate using the laser drying device according to the present disclosure, the method comprising the steps of:
irradiating an electrode mixture layer applied to a current collector layer with laser light.

According to the present disclosure, there can be provided a method for the production of an electrode laminate with high drying efficiency.

The method of the present disclosure is a method for the production of an electrode laminate using the laser drying device of the present disclosure. Regarding the laser drying device, reference can be made to the foregoing description of the laser drying device.

The method of the present disclosure comprises irradiating the electrode mixture layer applied to a current collector layer with laser light. Regarding the details of the electrode mixture layer and the laser light, reference can be made to the foregoing descriptions of the laser drying device. By irradiating the electrode mixture layer with laser light, the dispersion medium contained in the electrode mixture layer volatilizes, whereby an electrode active material layer is formed.

The dispersion medium contained in the electrode mixture layer is not particularly limited, and may be, for example, a non-polar solvent such as heptane, xylene, or toluene, or a polar solvent such as water, a tertiary amine solvent, an ether solvent, a thiol solvent, a ketone solvent (for example, diisobutyl ketone), or an ester solvent (for example, butyl butyrate).

The content of the dispersion medium is not particularly limited, and may be, for example, a quantity such that the solid content of the electrode mixture layer is 30% or more, 35% or more, 40% or more, 45% or more, or 50% or more, and may be a quantity such that the solid content of the electrode mixture layer is 80% or less, 75% or less, 70% or less, 65% or less, or 60% or less.

The method for applying the electrode mixture layer is not particularly limited, and a doctor blade method, a die coating method, a gravure coating method, a spray coating method, an electrostatic coating method, a bar coating method, etc., may be adopted.

The irradiation time of the laser light is not particularly limited, and for example, irradiation may be performed until the decreasing rate drying period of the electrode mixture layer is reached. The irradiation time of the laser light may be, for example, 30 seconds or more, 1 minute or more, or 2 minutes or more, and may be 30 minutes or less, 20 minutes or less, or 10 minutes or less.

### <Electrode Laminate>

The electrode laminate may comprise an electrode active material layer and a current collector layer. The electrode active material layer may be a positive electrode active material layer or a negative electrode active material layer. The electrode laminate may also be a bipolar electrode laminate having a positive electrode active material layer and a negative electrode active material layer.

### (Electrode Active Material Layer)

When the electrode active material layer of the present disclosure is a positive electrode active material layer, the positive electrode active material layer contains at least a positive electrode active material. When the electrode active material layer is a negative electrode active material layer, the negative electrode active material layer contains at least a negative electrode active material. The electrode active material layer may further contain, as desired, a binder, a solid electrolyte, a conductive additive, etc. The electrode active material layer may also contain various other additives. The contents of the positive electrode active material, the negative electrode active material, the binder, the solid electrolyte, the conductive additive, etc., in the electrode active material layer may be appropriately determined in accordance with the desired battery performance.

The material of the positive electrode active material is not particularly limited as long as it is capable of absorbing and releasing lithium ions. Examples of the positive electrode active material include, but are not limited to, lithium cobalt oxide (LiCoO₂), lithium nickel oxide (LiNiO₂), lithium manganese oxide (LiMn₂O₄), lithium iron phosphate (LFP), lithium manganese iron phosphate (LMFP), nickel-cobalt-manganese lithium oxide (NCM: LiCO_{1/3}Ni_{1/3}Mn_{1/3}O₂), nickel-cobalt-aluminum lithium oxide (LiNi_{0.8}(CoAl)_{0.2}O₂), and heteroelement-substituted Li—Mn spinels having a composition represented by Li₁₊ₓMn_{2-x-y}M_{y}O₄ (where M is one or more metal elements selected from Al, Mg, Co, Fe, Ni, and Zn).

The form of the positive electrode active material is not particularly limited as long as it is a form which is generally adopted for the positive electrode active material of batteries. The positive electrode active material may be, for example, particulate. The positive electrode active material may be primary particles or secondary particles formed by aggregation of a plurality of primary particles. The average particle diameter D₅₀ of the positive electrode active material may be, for example, 1 nm or more, 5 nm or more, or 10 nm or more, and may be 500 μm or less, 100 μm or less, 50 μm or less, or 30 μm or less. The average particle diameter D₅₀ is the particle diameter (median diameter) at 50% of the integrated value in the volume-based particle size distribution determined by a laser diffraction/scattering method.

As the negative electrode active material, various materials which have a potential (charge/discharge potential) for absorbing and releasing lithium ions that is lower than that of the positive electrode active material of the present disclosure can be used. The material of the negative electrode active material is not particularly limited, and may be metallic lithium or a material which is capable of absorbing and releasing metal ions such as lithium ions. Examples of materials which are capable of absorbing and releasing metal ions such as lithium ions include, but are not limited to, alloy-based negative electrode active materials, carbon materials, and lithium titanate (Li₄Ti₅O₁₂).

The alloy-based negative electrode active material is not particularly limited, and examples thereof include Si alloy-based negative electrode active materials and Sn alloy-based negative electrode active materials. Examples of Si alloy-based negative electrode active materials include silicon, silicon oxide, silicon carbide, silicon nitride, and solid solutions thereof. The Si alloy-based negative electrode active material can contain metal elements other than silicon, such as Fe, Co, Sb, Bi, Pb, Ni, Cu, Zn, Ge, In, Sn, Ti, etc. Examples of Sn alloy-based negative electrode active materials include tin, tin oxide, tin nitride, and solid solutions thereof. The Sn alloy-based negative electrode active material can contain metal elements other than tin, such as Fe, Co, Sb, Bi, Pb, Ni, Cu, Zn, Ge, In, Ti, Si, etc.

The carbon material is not particularly limited, and examples thereof include hard carbon, soft carbon, graphite, etc.

The form of the negative electrode active material is not particularly limited as long as it is a form which is generally adopted for the negative electrode active material of batteries. The negative electrode active material may be, for example, in the form of particles or a sheet.

The material of the binder is not particularly limited. The binder may be, for example, polyvinylidene fluoride (PVdF), butadiene rubber (BR), polytetrafluoroethylene (PTFE), styrene butadiene rubber (SBR), etc., but is not limited thereto. The binder is not particularly limited, and one type may be used alone, or two or more types may be used in combination.

The material of the solid electrolyte is not particularly limited, and may be, for example, a sulfide solid electrolyte, an oxide solid electrolyte, or a polymer electrolyte.

Examples of sulfide solid electrolytes include, but are not limited to, sulfide-based amorphous solid electrolytes, sulfide-based crystalline solid electrolytes, and argyrodite-type solid electrolytes. Specific examples of sulfide solid electrolytes include Li₂S—P₂S₅-based electrolytes (Li₇P₃S₁₁, Li₃PS₄, Li₈P₂S₉, etc.), Li₂S—SiS₂, LiI—Li₂S—SiS₂, LiI—Li₂S—P₂S₅, LiI—LiBr—Li₂S—P₂S₅, Li₂S—P₂S₅—GeS₂ (Li₁₃GeP₃S₁₆, Li₁₀GeP₂S₁₂, etc.), LiI—Li₂S—P₂O₅, LiI—Li₃PO₄—P₂S₅, Li₇₋ₓPS₆₋ₓClₓ, etc.; or combinations thereof.

Examples of oxide solid electrolytes include, but are not limited to, Li₇La₃Zr₂O₁₂, Li₇₋ₓLa₃Zr₁₋ₓNbₓO₁₂, Li₇₋₃ₓLa₃Zr₂AlₓO₁₂, Li₃ₓLa_{2/3-x}TiO₃, Li₁₊ₓAlₓTi₂₋ₓ(PO₄)₃, Li₁₊ₓAlₓGe₂₋ₓ(PO₄)₃, Li₃PO₄, or Li₃₊ₓPO₄₋ₓNₓ (LiPON), etc.; or combinations thereof.

The sulfide solid electrolyte and the oxide solid electrolyte may be glass or crystallized glass (glass ceramics).

Examples of polymer electrolytes include, but are not limited to, polyethylene oxide (PEO), polypropylene oxide (PPO), and copolymers thereof.

The conductive additive is not particularly limited. The conductive additive may be, for example, vapor-grown carbon fiber (VGCF), acetylene black (AB), Ketjen black (KB), carbon nanotubes (CNT), carbon nanofibers (CNF), etc., but is not limited thereto. The conductive additive may be, for example, particulate or fibrous, and the size thereof is not particularly limited. The conductive additive is not particularly limited, and one type may be used alone, or two or more types may be used in combination.

### (Current Collector Layer)

The material of the current collector layer is not particularly limited, and any conductor which is commonly used in battery electrodes can be appropriately used. Examples of materials for the conductor layer include, but are not limited to, Cu, Ni, Cr, Au, Pt, Ag, Al, Fe, Ti, Zn, Co, and stainless steel. The current collector layer may also be a metal foil or a substrate on which a metal described above is plated or vapor-deposited.

The form of the current collector layer is not particularly limited, and examples thereof include foil, plate, mesh, etc. Among these, foil is preferable.

The thickness of the current collector layer is not particularly limited, and may be 0.1 μm or more, or 1 μm or more, and may be 1 mm or less, or 100 μm or less.

### EXAMPLES

The present invention will be specifically described with reference to Examples and Comparative Examples, but the present invention is not limited thereto.

### <<Laser Drying Device>>

Two laser-transmitting protective plate pieces were combined as shown in FIGS. 4(a) to 4(c) to prepare the laser-transmitting protective plates of Examples 1 to 6. The laser-transmitting protective plate pieces were made of quartz glass and measured 1,200 mm in width, 750 mm in the conveyance direction, and 1.5 mm in thickness. The two laser-transmitting protective plate pieces were combined to form a laser-transmitting protective plate measuring 1,500 mm in the conveyance direction and 1,200 mm in width. The gel substance of FIGS. 4(a) and 4(c) was a fluorine-based gel (Novec Fluorochemical Gel, manufactured by 3M). The cross-sectional shape of the gel substance or the gap between the laser-transmitting protective plate pieces in FIG. 4 in the height direction is a rectangle in FIGS. 4A and 4B and a parallelogram in FIG. 4C.

The laser-transmitting protective plates in which the distance (distance a) between adjacent laser-transmitting protective plate pieces in FIG. 4A was 0.1 mm, 1 mm, or 3 mm were used as the laser-transmitting protective plates of Examples 1 to 3, respectively, and the laser-transmitting protective plates in which the distance a in FIG. 4B was 0.1 mm, 1 mm, or 3 mm were used as the laser-transmitting protective plates of Examples 4 to 6, respectively, and the laser-transmitting protective plates in which the distance a in FIG. 4C was 0.1 mm, 1 mm, or 3 mm were used as the laser-transmitting protective plates of Examples 7 to 9, respectively. Furthermore, a laser-transmitting protective plate in which the laser-transmitting protective plate pieces were connected without gaps and without a gel substance therebetween was prepared as the laser-transmitting protective plate of Comparative Example 1.

Further, the laser drying device having the structure shown in FIG. 1 was used as the laser drying device for Examples 1 to 9 and Comparative Example 1. The laser light source had an output of 50 kW and was arranged so that an irradiation area of 1,300 mm in the conveyance direction and 1,000 mm in the width direction at the center of the laser-transmitting protective plate for Examples 1 to 9 and Comparative Example 1 could be irradiated with the laser light. The hot air supply equipment was capable of supplying hot air at 200° C. to the interior of the furnace body.

### <<Durability Evaluation of Laser-Transmitting Protective Plate>>

In the laser drying devices of Examples 1 to 9 and Comparative Example 1, laser light irradiation and hot air supply to the furnace body were performed for two consecutive hours, and the devices were then allowed to cool naturally to ambient temperature. This process was repeated for 10 repetitions, after which the laser-transmitting protective plates were visually inspected for damage, and durability was evaluated.

The evaluation results are shown in Table 1.

TABLE 1

| | Laser-transmitting protective plate | | | Evaluation |
|---|---|---|---|---|
| | Presence/ | | | Presence/absence |
| | absence | Cross- | Distance | of damage to |
| | of gel | sectional | a | laser-transmitting |
| | substance | shape | (mm) | protective plate |
| Ex 1 | Present | Rectangle | 0.1 | Absent |
| Ex 2 | Present | Rectangle | 1 | Absent |
| Ex 3 | Present | Rectangle | 3 | Absent |
| Ex 4 | Absent | Parallelogram | 0.1 | Absent |
| Ex 5 | Absent | Parallelogram | 1 | Absent |
| Ex 6 | Absent | Parallelogram | 3 | Absent |
| Ex 7 | Present | Rectangle | 0.1 | Absent |
| Ex 8 | Present | Rectangle | 1 | Absent |
| Ex 9 | Present | Rectangle | 3 | Absent |
| Comp Ex 1 | Absent | — | 0 | Present |

It can be understood from Examples 1 to 9 and Comparative Example 1 that by including a laser-transmitting protective plate in which adjacent laser-transmitting protective plate pieces were joined to each other via a gel substance or arranged with a gap therebetween in the laser drying device, thermal cracking did not occur in the laser-transmitting protective plate even when the temperature inside the furnace body was high. Thus, instead of preparing a single large-area laser-transmitting protective plate, a plurality of laser-transmitting protective plate pieces can be combined to form a large-area laser-transmitting protective plate.

### <<Evaluation of Drying Efficiency>>

### <Laser Drying Device>

Laser drying devices having the same configuration as shown in FIG. 1 except that the laser-transmitting protective plate was a single plate were prepared as Reference Examples 1 to 5 and Reference Comparative Example 1. The distance y between the laser-transmitting protective plate and the electrode mixture layer of each Example was adjusted as shown in Table 2. The distance x between the laser light source and the electrode mixture layer was 1,500 mm. The laser-transmitting protective plate was made of quartz glass, and the transmittance of the laser light emitted from the 20 kW laser light source was 99.8% at a wavelength of 970 nm. The transmittance of the laser light was measured spectrophotometrically using a UV-Vis-Near-Infrared Spectrophotometer (SolidSpec-3700DUV manufactured by Shimadzu Corporation). The temperature of the hot air supplied from the hot air supply equipment was 120° C.

### <Electrode Mixture Layer>

An electrode mixture layer was prepared by mixing lithium cobalt oxide (LiCoO₂) as the electrode active material and styrene-butadiene copolymer (SBR) as the binder weighed at a mass ratio of 97.5:2.5 with ion-exchanged water at a solid content of 55%. Note that the basis weight of the electrode mixture layer was 35 mg/cm².

### <Evaluation of Drying Time>

The electrode mixture layer described above was applied to an aluminum foil serving as a current collector layer at a thickness of 400 μm, and the layer was then introduced into the laser drying devices of Reference Examples 1 to 5 and Reference Comparison Example 1, and the area including the center of the electrode mixture layer was irradiated with laser light.

The temperature at the center of the electrode mixture layer was continuously measured with a radiation thermometer, and the point at which the center of the electrode mixture layer entered a decreasing rate of drying was defined as the drying time. The drying times of the electrode mixture layer for the laser drying devices of Reference Examples 1 to 5 and Reference Comparison Example 1 are shown in Table 2.

TABLE 2

| | Laser light source | Laser-transmitting | | Drying |
|---|---|---|---|---|
| | position | protective plate position | | time |
| | x | y | x/y | (s) |
| Comp Ref Ex 1 | 1500 | 300 | 0.20 | 106 |
| Ref Ex 1 | 1500 | 200 | 0.13 | 85 |
| Ref Ex 2 | 1500 | 150 | 0.10 | 80 |
| Ref Ex 3 | 1500 | 100 | 0.07 | 74 |
| Ref Ex 4 | 1500 | 50 | 0.03 | 65 |
| Ref Ex 5 | 1500 | 10 | 0.01 | 50 |

From Reference Examples 1 to 5 and Reference Comparative Example 1, it can be understood that by reducing x/y, drying time is reduced. Thus, by using a large-area laser-transmitting protective plate and reducing x/y, drying efficiency can be improved.

### REFERENCE SIGNS LIST

100 laser drying device
110 furnace body
111 exterior base material
112 laser-transmitting protective plate
112-1 laser-transmitting protective plate pieces
112-2 gel substance
120 laser light source
130 conveying equipment
131 conveyor belt
132 conveyor roller
140 hot air supply equipment
141 hot air generator
142 air supply duct
143 air supply nozzle
150 exhaust equipment
200 laser light
300 electrode mixture layer

1. A laser drying device for drying an electrode mixture layer, wherein
the laser drying device comprises a furnace body and a laser light source,
the furnace body comprises a laser-transmitting protective plate comprising a plurality of laser-transmitting protective plate pieces which transmit laser light,
the laser light source irradiates the electrode mixture layer in the furnace body with laser light via the laser-transmitting protective plate,
the plurality of laser-transmitting protective plate pieces are aligned in a plane direction, and
adjacent laser-transmitting protective plate pieces are joined to each other via a gel substance or arranged with a gap.

2. The laser drying device according to claim 1, wherein the gel substance is selected from a fluorine-based gel, a silicone-based gel, an acrylic gel, and combinations of these.

3. The device according to claim 1, wherein adjacent laser-transmitting protective plate pieces are arranged with a gap, and a negative pressure is generated in the furnace body.

4. The device according to claim 1, wherein the furnace body further comprises hot air supply equipment.

5. A method for the production of an electrode laminate using the device according to claim 1, the method comprising the step of:
irradiating an electrode mixture layer applied to a current collector layer with laser light.
